(19) United States
(12) Patent Application Publication
(10) Pub. No.: US 2015/0060381 A1
(43) Pub. Date: Mar. 5, 2015

(54) UNIVERSAL ADJUSTABLE PALLET RACK LOAD STOP ASSEMBLY

(71) Applicant: ROBERT M CONSAUL, SAN CARLOS, CA (US)

(72) Inventor: ROBERT M CONSAUL, SAN CARLOS, CA (US)

(21) Appl. No.: 14/011,743

(22) Filed: Aug. 27, 2013

(51) Int. Cl. A47B 47/02; B65G 1/16

(52) U.S. Cl. CPC A47B 47/028; B65G 1/16; B65G 2207/40
USPC 211/183

(57) ABSTRACT

The new adjustable pallet rack stopper assembly facilitates the positioning of a pallet onto or under a pallet rack to prevent damage to a facility caused by the pallet, itself, or by material handling equipment during the pallet positioning process, as well as to prevent general displacement of the pallet while preserving necessary space between the pallet and the facility wall, piping, doors, electrical conduit, or other items adjacent to the pallet rack. The present invention is a compact, highly adaptable, and inexpensively elegant solution to these common problems arising in storage facilities using pallet rack storage systems.

### CROSS-REFERENCE TO RELATED APPLICATIONS

None.

### FEDERALLY-SPONSORED RESEARCH

Not applicable.

### SEQUENCE LISTING

Not applicable.

### BACKGROUND

The new load stop assembly concerns a universal, adjustable pallet rack stopper apparatus for facilitating positioning of a pallet on a pallet rack to prevent damage to a storage facility caused by the pallet, itself, or by material handling equipment during the pallet positioning process, as well as to prevent general displacement of the pallet while preserving necessary space between the pallet and the facility wall or other pallets.

Pallet racks are often used in warehouses and retail facilities for pallet material storage, and placement of pallets onto and under pallet racks is generally accomplished using a forklift or other material handling equipment such as pallet jacks. This system presents some common problems, including: 1) damage to walls, 2) interference with the minimum space required between pallet racks or between a pallet rack and wall, and 3) potential injury to persons or products from materials falling off of pallet racks. Over the past few decades, several devices have been developed to address similar issues with material storage on pallet racks, but none comprises the same features nor covers the scope of advantages the present invention affords.

Other systems—specifically, those described in U.S. Pat. No. 6,758,448; U.S. Pat. No. 7,059,573; U.S. Pat. No. 5,573,125; and Pub. No. U.S. 2007/0187349 A1 —have been designed to prevent items from falling off shelving or rack units. The common net-and-cable design does not prevent damage to walls, maintain minimum spacing in compliance with federal or local food storage regulations stipulated by agencies, such as the USDA or county public health departments, or provide a guide for material handlers to align and place pallets, which are prime advantages of the present invention.

There are other adapter-type devices that can be used independently or in conjunction with other materials for, primarily, pallet alignment purposes. These types of devices are described in U.S. Pat. No. 4,618,064; U.S. Pat. No. 6,173,846; and Pub. No. US 2009/0084746 A1. These inventions each require some combination of drilling, mounting, installing specialized hardware, and/or installing the invention during the pallet rack manufacturing process. Further, devices such as that described in U.S. Pat. No. 6,173,846 are limited to use on pallet rack shelves and cannot be used in floor-level bays. The new load stop assembly, however, adapts to pre-existing pallet rack features without having to drill holes or use specialized hardware, and it can be used in both shelf- and floor-level bays.

Existing devices available on the market are designed to prevent wall damage caused by pallet jacks or forklifts. Indeed, the use of backstop support bars for shelving units is known in the art, and such supports for pallet racks are usually referred to as “load stops.” These load stops are one-piece metal beams that connect the upright (vertical) beams of any size pallet rack. The standard load stop design does not universally fit onto pallet racks and, therefore, must be special-ordered according to the pallet rack bay size and desired clearance. As a result, the load stops can be very costly to purchase, and production and delivery time can be quite prohibitive. The new universal, adjustable load stop assembly provides a ready means of inexpensive protection for warehouses and retail locations using pallet rack storage systems.

### SUMMARY OF THE INVENTION

The general purpose of the new adjustable load stop is to provide a simple, yet versatile and adaptable, mechanism for restricting the movement of loaded pallets on and off pallet racks and within any level of pallet rack bay. In general, the load stop secures horizontally to the back of the pallet rack such that it prevents damage to walls from otherwise protruding forklifts, pallets and other devices that might be used to load and position pallets onto pallet racks.

This adjustable load stop allows for universal use with a variety of pallet rack styles found in hundreds of thousands of existing warehouse facilities. The new stopper presents to manufacturers of pallet racks a low-cost alternative to creating the one-piece pallet rack load stop bars on the market today, as it can be fabricated using less material and in one, universal model that fits any size bay in any type of pallet rack. Further, the telescoping, adjustable load stop is compact and easy to stock in supply houses making it readily available for customer acquisition, unlike standard load stops, which must be custom-made.

The embodiments described herein are illustrative of the invention, and it is to be understood that the invention is not limited in its application to the details of construction and to the arrangements of the components set forth in the following description and drawings. The invention is capable of other embodiments and of being practiced and carried out in various ways. It should be further understood that the phraseology and terminology applied herein merely serve the purpose of description and should not be regarded as limiting.

### BRIEF DESCRIPTION OF THE DRAWINGS

FIG. 1 shows the side view of an end mounting plate of the adjustable load stop.

FIG. 2 shows the top or bottom view of the adjustable load stop.

FIG. 3 shows the front or back view of the adjustable load stop.

FIG. 4 shows a three-dimensional view of the adjustable load stop.

### DETAILED DESCRIPTION

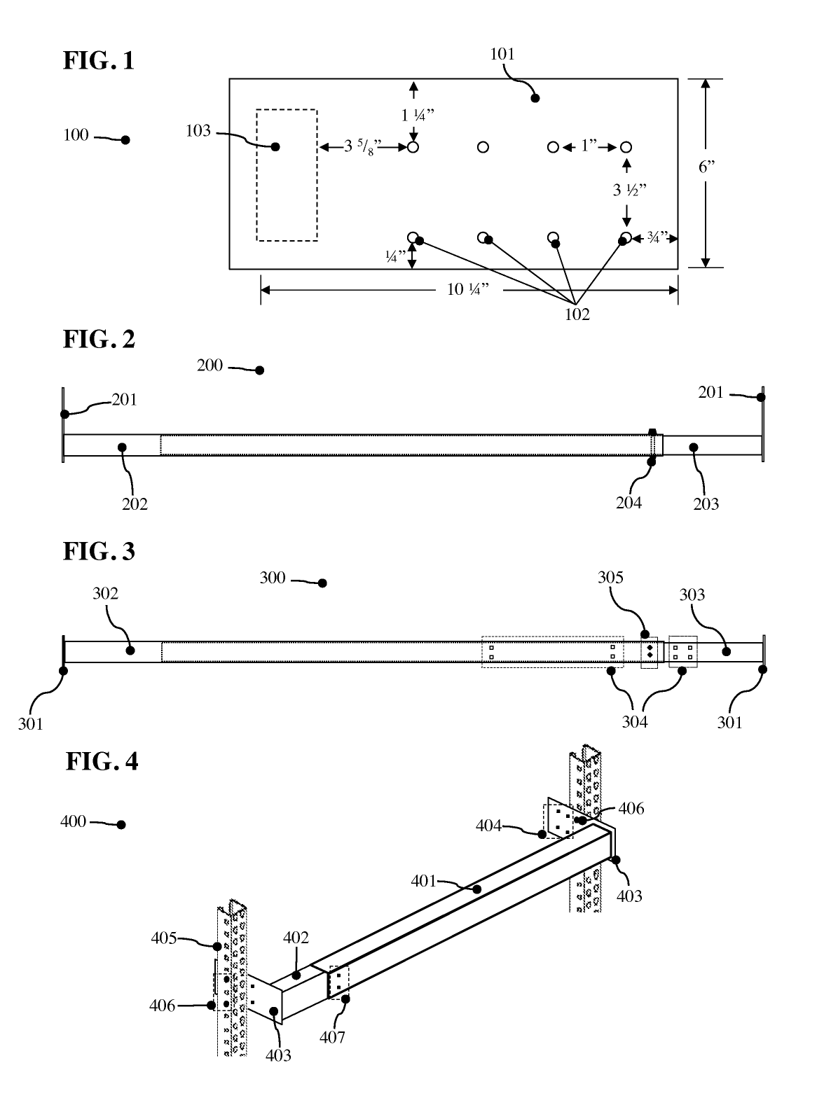

FIG. 1 shows the side view of an end mounting plate 100 of one embodiment of the adjustable load stop. Each mounting plate consists, generally, of two mounting plates 101, each having two rows of four equally spaced holes 102 and denoting the footprint 103 where the mounting plate is welded to the load stop beam. In the depicted embodiment, the eight pre-drilled holes 102 are 7/16″ in diameter and are spaced 1″ apart horizontally and 3½″ apart vertically for proper alignment with—and mounting to—a pallet rack upright beam.

FIG. 2 shows the top or bottom view 201 of one embodiment of the adjustable load stop having two mounting plates 201 affixed to opposing ends of telescoping square tubes 202, 203. In the embodiment depicted, the inner tube 203 contains a series of complementary holes through each two opposing sides of the square tubing, and the outer tube 202 contains two complimentary holes through each of two opposing sides of the square tubing. Two bolts 204 are inserted through overlapping holes of the nested inner and outer tubes to secure them in the desired position and prevent further sliding.

FIG. 3 shows the front or back view 301 of the above-described embodiment of the adjustable load stop having two mounting plates 301 affixed to opposing ends of telescoping square tubes 302, 303. In the embodiment depicted, the inner tube 303 contains a series of complementary holes through each two opposing sides of the square tubing, and the outer tube 302 contains two complimentary holes through each of two opposing sides of the square tubing. Two bolts 304 are inserted through overlapping holes of the nested inner and outer tubes to secure them in the desired position and prevent further sliding.

FIG. 4 shows a three-dimensional view 401 of the above-described embodiment of the adjustable load stop having an outer square tube 401 partially enveloping an inner square tube 402 and being secured in position by two bolts 407 each inserted through overlapping holes in the nested tubes. Each tube is attached at its distal end to a mounting plate 403 having two vertically aligned rows of four holes 404 each. The adjustable load stop is secured into position on a pallet rack by attachment of the mounting plates 403 to two opposing vertical pallet rack beams 405 via bolts 406 extending through overlapping holes in the mounting plates and rack beams. Desired clearance between 3 to 12-inches can be achieved by varying placement of the securing bolts 406 in one of the four vertical sets of holes 404. Load stop beams are 14-gauge for light duty and 11-gauge for heavy duty. Tubing size can also be varied to increase durability (e.g., 2×3-inch tubing versus 2×2-inch tubing). The above-described embodiment would be suitable for any pallet rack bay having a bay size of 60-inches to 144-inches.

As to further discussion of the manner of usage and operation of the present invention, the same should be apparent from the above description. With respect to the above description then, it is to be realized that the optimum dimensional relationships for the parts of this invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention, the use of which results in a bumper system that:
Keeps material handlers from placing product beyond the perimeter of the pallet rack bay, which can result in damaged walls or product;
Makes it easier for material handlers to accurately place pallets inside pallet rack bays or on the floor beneath pallet rack shelves because the bumper provides a guide to assist them with properly aligning pallets; and
Prevents pallets from being placed too close to walls in violation of federal and/or local health code regulations. For example, that a 12-inch gap exist between the back side of a pallet of food items and the proximal wall or other stored product to maintain clearance sufficient to accommodate rodent traps.

Although the description presented heretofore contains specificities for the benefit of illustration, these should not be construed as limiting the scope of the embodiments but rather as illustrative examples of some of the several embodiments. For example, adjustable load stop assemblies can and should be made from steel of a gauge thickness and connection type complimentary to that used in the uprights and horizontal beams with which the load stop assembly will be utilized. Thus, the scope of the embodiments should be determined by the appended claims and their legal equivalents rather than by the examples provided.

What is claimed is:

1. An adjustable pallet rack load stop assembly, comprising:
first end means having a mounting plate with a plurality of connection members of a suitable quantity, shape and arrangement for attachment to a first vertical pallet rack beam;
second end means having a mounting plate with a plurality of connection members of a suitable quantity, shape and arrangement for attachment to a second vertical pallet rack beam;
support means for connecting said first and second end means, orienting said first and second end means such that the first end means attaches to the second end means and where each of two opposing sides of the support means is secured at an angle generally perpendicular to each of the said first and second end means.

2. An adjustable pallet rack load stop assembly as defined in claim 1 wherein said support means is a plurality of relatively slidable inner and outer telescoping tubes cooperatively defining a range of pallet rack lengths having opposed ends and a plate mounted at each of the opposed ends for mounting to opposing vertical pallet rack beams; said telescoping tubes including a first tube being slidable inside a second tube, and a lock member for locking the tubes at said additional extended position.

3. An adjustable pallet rack load stop assembly as defined in claim 2 wherein said lock member is a plurality of holes in the inner telescoping tube and a plurality of holes in the outer telescoping tube positioned such that said holes in said inner tube overlap with said holes in said outer tube at intervals when sliding said tubes; securing means for insertion through overlapping holes in said tubes to prevent further sliding.

4. An adjustable pallet rack load stop assembly as defined in claim 2 wherein the fully collapsed length of the bar is a length of a conventional pallet.

5. An adjustable pallet rack load stop assembly as defined in claim 1 wherein said plurality of connection members in the mounting plate of the first end means comprises two rows of four holes each being vertically aligned; each hole being 7/16-inch in diameter; said rows being spaced 3½-inch vertically; said holes being spaced 1-inch horizontally.

6. An adjustable pallet rack load stop assembly as defined in claim 1 wherein said plurality of connection members in the mounting plate of the second end means comprises two rows of four holes each being vertically aligned; each hole being 7/16-inch in diameter; said rows being spaced 3½-inch vertically; said holes being spaced 1-inch horizontally.

7. An adjustable pallet rack load stop assembly as defined in claim 1 wherein said support means is of a style chosen from the group comprising square tubing, rectangular tubing, round tubing and channel tubing.
